(19) United States
(12) Patent Application Publication
(10) Pub. No.: US 2017/0200044 A1
(43) Pub. Date: Jul. 13, 2017

(54) APPARATUS AND METHOD FOR PROVIDING SURVEILLANCE IMAGE BASED ON DEPTH IMAGE

(71) Applicant: ELECTRONICS AND TELECOMMUNICATIONS RESEARCH INSTITUTE, Daejeon (KR)

(72) Inventors: Jae Ho LEE, Daejeon (KR); Hee Kwon KIM, Daejeon (KR); Soon Chan PARK, Daejeon (KR); Ji Young PARK, Daejeon (KR); Kwang Hyun SHIM, Daejeon (KR); Moon Wook RYU, Seoul (KR); Ju Yong CHANG, Daejeon (KR); Ho Wook JANG, Daejeon (KR); Hyuk JEONG, Daejeon (KR)

(21) Appl. No.: 15/211,426

(22) Filed: Jul. 15, 2016

(30) Foreign Application Priority Data
Jan. 8, 2016 (KR) 10-2016-0002483

(51) Int. Cl. G06K 9/00; G06T 7/00; G06T 7/40; H04N 7/18

(52) U.S. Cl. CPC G06K 9/00221; H04N 7/181; G06K 9/00335; G06T 7/0022; G06T 7/408; G06T 2207/10024; G06T 2207/10028

(57) ABSTRACT

An apparatus and a method for providing a surveillance image based on a depth image. The apparatus according to the present invention includes: a first camera capturing a depth image for a subject in a predetermined capturing region; a second camera capturing a color image for the subject in the predetermined capturing region; a subject identification unit identifying a subject in the capturing region; an image processing unit extracting the color image corresponding to a region of the identified subject from the color image and synthesizing the extracted color image with a position corresponding to the depth image to generate a synthesized image; and a control unit providing the depth image when the subject is not identified by the subject identification unit and providing the synthesized image only when the subject is identified by the subject identification unit.

### CROSS-REFERENCE TO RELATED APPLICATIONS

This application claims priority to and the benefit of Korean Patent Application No. 10-2016-0002483 filed in the Korean Intellectual Property Office on Jan. 8, 2016, the entire content of which is incorporated herein by reference.

### BACKGROUND OF THE INVENTION

1. Field of the Invention

The present invention relates to an apparatus and a method for providing a surveillance image based on a depth image.

2. Description of Related Art

A CCTV surveillance system has been developed to a network type surveillance system due to the development of Internet technology.

The CCTV surveillance system has become a good means that captures and records an image of a specific region through a CCTV camera and provides the recorded image as it is to objectively verify a crime scene.

However, in the CCTV surveillance system in the related art, since the image recorded through the CCTV camera is recorded and transmitted as it is, faces for objects other than a surveillance object are exposed as they are, and as a result, problems such as invasion of individual privacy, and the like have continuously occurred.

In order to solve the problem associated with the invasion of the individual privacy, a privacy masking scheme that masks a specific region or specific object in an image before transmitting the image captured by the CCTV camera and thereafter, transmits the corresponding image is applied, but a problem may occur in that an image processing amount increases and further, even information on a specific image is damaged during masking in order to apply the privacy masking scheme to all images.

### SUMMARY OF THE INVENTION

The present invention has been made in an effort to provide an apparatus and a method for providing a surveillance image based on a depth image which solve a privacy invasion problem caused as information associated with individual privacy is exposed as it is and provide a color image only to a specific subject when an image transmitted from a surveillance camera is monitored in a security center.

The technical objects of the present invention are not limited to the aforementioned technical objects, and other technical objects, which are not mentioned above, will be apparently appreciated to a person having ordinary skill in the art from the following description.

An exemplary embodiment of the present invention provides an apparatus for providing a surveillance image based on a depth image, including: a first camera capturing a depth image including distance information on a subject in a predetermined capturing region; a second camera capturing a color image for the subject in the predetermined capturing region; a subject identification unit identifying a subject designated as an interest object or a subject performing a suspicious action in the capturing region; an image processing unit extracting the color image corresponding to a region of the identified subject from the color image and synthesizing the extracted color image with a position corresponding to the depth image to generate a synthesized image; and a control unit providing the depth image as a surveillance image when the subject is not identified by the subject identification unit and providing the synthesized image as the surveillance image only when the subject is identified by the subject identification unit.

The subject identification unit may identify the corresponding subject positioned in the capturing region based on a signal received from a sensor which an interest object positioned in a predetermined range wears from the corresponding surveillance image providing apparatus.

The subject identification unit may identify the corresponding subject positioned in the capturing region by detecting an identification means which the interest object wears from the color image.

The subject identification unit may identify the corresponding subject positioned in the capturing region by detecting a face image corresponding to the interest object from the color image.

The apparatus may further include a skeleton information extracting unit extracting skeleton information from the depth image.

The subject identification unit may identify the corresponding subject positioned in the capturing region by detecting a suspicious action based on the skeleton information extracted from the depth image.

The skeleton information extracting unit may extract the skeleton information corresponding to the identified object from the depth image.

The image processing unit may add the skeleton information corresponding to the identified subject to the region corresponding to the corresponding subject in the depth image.

The image processing unit may add the skeleton information corresponding to the identified subject to the region corresponding to the corresponding subject in the synthesized image.

The image processing unit may determine positional information of the region of the identified subject in the depth image and extract a color image of a region extended at a predetermined ratio based on the region corresponding to the determined positional information in the color image.

The image processing unit may extract an outline for the identified subject in the depth image and extract a color image of a region matching the extracted outline in the color image.

Another exemplary embodiment of the present invention provides a method for providing a surveillance image based on a depth image, including: by a surveillance image providing apparatus, capturing a depth image including distance information for a subject in a predetermined capturing region by a first camera and capturing a color image for the subject in the predetermined capturing region by a second camera; identifying a subject designated as an interest object or a subject performing a suspicious action in the capturing region; and providing the depth image as a surveillance image when the subject is not identified in the capturing region and providing a synthesized image generated by synthesizing a color image corresponding to the region of the identified subject with a position corresponding to the depth image as the surveillance image in the color image when the object is identified in the capturing region.

According to exemplary embodiments of the present invention, a basic surveillance image is provided as a depth image to solve a primary invasion problem as information associated with individual privacy is exposed as it is when an image transmitted from a surveillance camera is monitored in a security center.

A color image is provided to a specific object predesignated as an interest object or a subject that performs a specific action from an image captured by the camera to solve the invasion of the individual privacy and provide an image that facilitates identification of the specific object.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a configuration of an apparatus for providing a surveillance image based on a depth image according to the present invention.

FIG. 2 is a diagram illustrating an exemplary embodiment of the depth image provided by the apparatus for providing a surveillance image based on a depth image according to the present invention.

FIGS. 3A to 3D is a diagram illustrating an exemplary embodiment of an operation of identifying the specific subject in the apparatus for providing a surveillance image based on a depth image according to the present invention.

FIG. 4 is a diagram illustrating an exemplary embodiment of an operation of generating a synthesized image in the apparatus for providing a surveillance image based on a depth image according to the present invention.

FIGS. 5A and 5B is a diagram illustrating an exemplary embodiment of an operation of encapsulating skeleton information in the surveillance image in the apparatus for providing a surveillance image based on a depth image according to the present invention.

FIG. 6 is a diagram illustrating am operational flow for a method for providing a surveillance image based on a depth image according to the present invention.

FIG. 7 is a diagram illustrating a configuration of a computing system to which a server is applied according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

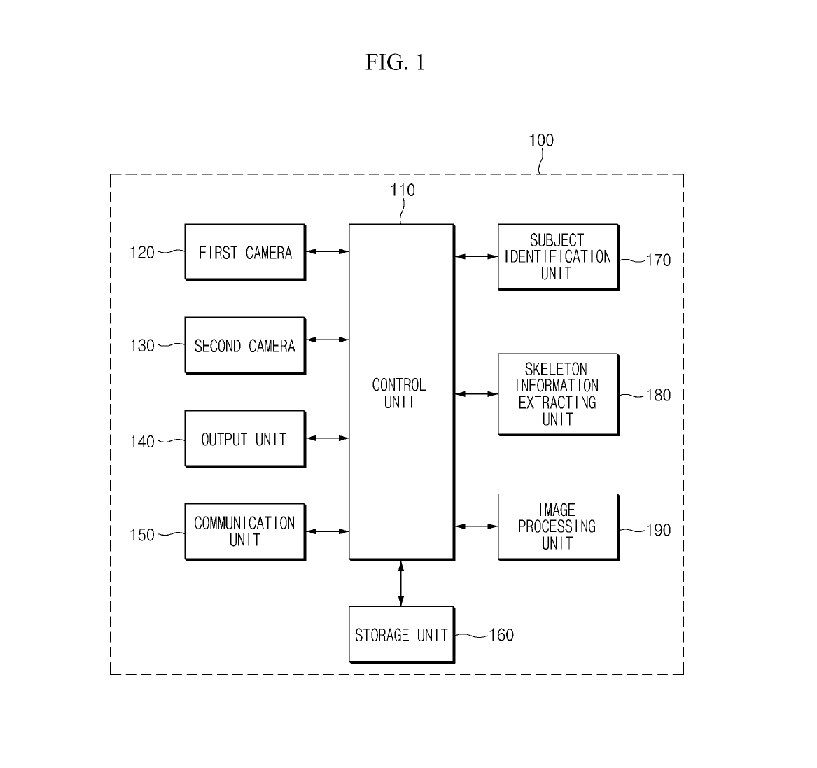

FIG. 1 is a diagram illustrating a configuration of an apparatus for providing a surveillance image based on a depth image according to the present invention.

Referring to FIG. 1, the apparatus (hereinafter, referred to as a ‘surveillance image providing apparatus’) 100 for providing a surveillance image based on a depth image may include a control unit 110, a first camera 120, a second camera 130, an output unit 140, a communication unit 150, a storage unit 160, a subject identification unit 170, a skeleton information extracting unit 180, and an image processing unit 190. Herein, the control unit 110 may process signals transferred among respective units of the surveillance image providing apparatus 100.

The first camera 120 may be a depth camera that captures a depth image including distance information on a subject in a predetermined capturing region. The first camera 120 captures the depth image for the predetermined capturing region and transfers the captured depth image to the control unit 110.

Meanwhile, the second camera 130 may be a color camera that captures a color image for the subject in the predetermined capturing region. In this case, the second camera 130 is configured to capture an image of the same region as the first camera 120. The second camera 130 captures the color image for the predetermined capturing region and transfers the captured color image to the control unit 110.

Herein, the first camera 120 and the second camera 130 may simultaneously capture the image for the predetermined capturing region in real time. Meanwhile, the first camera 120 may capture the image for the predetermined capturing region in real time and the second camera 130 may capture the image for the predetermined capturing region only when there is a request from the control unit 110.

In FIG. 1, it is illustrated that the first camera 120 and the second camera 130 are separately provided, but one camera in which the first camera 120 and the second camera 130 are integrated may be implemented. As one example, one integrated camera may be a stereo camera including a depth sensor and a color image sensor.

The output unit 140 may include a display displaying an operating status and an image of the surveillance image providing apparatus 100 and include a speaker.

Herein, when the display includes a sensor that senses a touch operation, the display may be used even as an input device in addition to an output device. That is, when touch sensors including a touch film a touch sheet, a touch pad, and the like are provided in the display, the display operates as a touch screen and an input unit and the output unit 140 may be implemented to be integrated.

In this case, the display may include at least one of a liquid crystal display (LCD), a thin film transistor-liquid crystal display (TFT LCD), an organic light-emitting diode (OLED), a flexible display, a field emission display (FED), and a 3D display.

However, when the display only serves to provide the surveillance image to a security center connected through a network, the output unit 140 may be omitted.

The communication unit 150 may include a communication module that supports wireless Internet communication or wired communication with the security center. As one example, a wireless Internet communication technology may include wireless LAN (WLAN), wireless broadband (Wibro), Wi-Fi, world interoperability for microwave access (Wimax), high speed downlink packet access (HSDPA), and the like and a wired communication technology may include universal serial bus (USB) communication, and the like.

The communication unit 150 may include a communication module that supports short-range communication with a sensor which an interest object such as a criminal wears within a predetermined range. Herein, the short-range communication technology may include Bluetooth, ZigBee, ultra wideband (UWB), radio frequency identification (RFID), infrared data association (IrDA), and the like.

The storage unit 160 may store data and programs which are required to operate the surveillance image providing apparatus 100. As one example, the storage unit 160 may store a set value for operating the surveillance image providing apparatus 100. Further, the storage unit 160 may store an algorithm for extracting the skeleton information from the depth image, an algorithm for identifying a specific subject from the color image, an algorithm for synthesizing the depth image and the color image, and the like.

Herein, the storage unit 160 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

The subject identification unit 170 serves to identify the specific subject designated as the interest object in the capturing region or a subject that performs a specific action.

As one example, the subject identification unit 170 may identify the specific subject positioned in the capturing region based on a signal received from a sensor which an interest object positioned in a predetermined range wears from the surveillance image providing apparatus 100.

The subject identification unit 170 may identify the specific subject positioned in the capturing region by detecting an identification means which the interest object wears from the color image captured by the second camera 130.

The subject identification unit 170 may identify the specific subject positioned in the capturing region by detecting a face image corresponding to the interest object from the color image captured by the second camera 130.

The subject identification unit 170 may identify the specific subject positioned in the capturing region by detecting a suspicious action based on the skeleton information extracted from depth image captured by the first camera 120.

In this case, the subject identification unit 170 may transfer the identification information for the specific subject in the capturing region to the control unit 110. Herein, the identification information for the specific subject may include positional information of the specific subject on the depth image and/or the color image.

The control unit 110 stores the depth image captured by the first camera 120 in the storage unit 160 as surveillance image and transmits the surveillance image stored in the storage unit 160 to the security center through the communication unit 150 when it is verified that the specific subject is not identified in the capturing region from the subject identification unit 170.

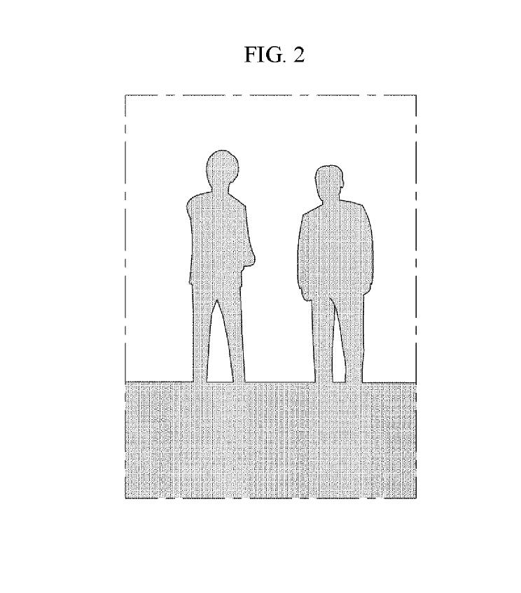

The depth image captured by the first camera 120 may be illustrated in FIG. 2. Accordingly, when the depth image illustrated in FIG. 2 is transmitted to the security center as the surveillance image, the individual privacy may be protected.

Meanwhile, the control unit 110 provides the identification information for the specific subject transferred from the subject identification unit 170 to the image processing unit 190 to request the generation of the synthesized image when it is verified that the specific subject is identified in the capturing region from the subject identification unit 170. Further, the control unit 110 provides the identification information for the specific subject transferred from the subject identification unit 170 to the skeleton information extracting unit 180 to request extraction of the skeleton information for the specific subject.

The skeleton information extracting unit 180 analyzes the depth image captured by the first camera 120 to extract the skeleton information. In this case, the skeleton information extracting unit 180 may extract information corresponding to a position and a direction of a joint by matching a skeleton model predefined in the depth image. Further, the skeleton information extracting unit 180 may extract the skeleton information for the depth image by applying the depth image to a skeleton extraction algorithm stored in the storage unit 160.

The skeleton information extracting unit 180 may transfer the skeleton information extracted from the depth image to the control unit 110 and/or the image processing unit 190. In this case, the control unit 110 may predict a motion and/or a posture of the subject based on the skeleton information extracted by the skeleton information extracting unit 180. Further, the image processing unit 190 may encapsulate the skeleton information in the depth image or the synthesized image of the depth image and the color image.

The image processing unit 190 serves to synthesize the depth image captured by the first camera 120 and the color image captured by the second camera 130 according to the request of the control unit 110.

Herein, when there is the generation request of the synthesized image from the control unit 110, the image processing unit 190 may detect a position of the specific subject in the depth image and a position of the specific subject in the color image based on the identification information for the specific subject provided from the control unit 110. In this case, the image processing unit 190 extracts the color image corresponding to a region at which the specific subject is positioned from the color image.

However, when the spatial information of the depth image and the spatial information of the color image do not match each other one to one, the image processing unit 190 may not determine an accurate position of the specific subject in the color image only by detecting the position of the specific subject in the depth image. In this case, in the color image extracted with respect to the specific subject, outline information may be lost or some informant may not be displayed.

Accordingly, the image processing unit 190 may extract the color image of the specific subject from the color image by using an extension region detection technique based on a base region of the color image or a color image outline extraction technique based on the spatial information of the depth image.

As one example, the image processing unit 190 may determine the positional information for the region of the specific subject in the depth image and extract the color image of an extended region at a predetermined ratio based on the region corresponding to the above determined positional information in the color image through the base region based extension region detection technique.

As another example, when the specific subject is identified in the depth image, the image processing unit 190 extracts an outline for the identified subject. In this case, the image processing unit 190 may extract the color image of the region matching the outline of the above extracted specific subject in the color image by using the color image outline extraction technique.

When detailed information such as the outline of the specific subject, and the like is not detected in the depth image, the image processing unit 190 compares temporal frames of the depth image to detect the information of the specific subject. As described above, when the color image for the specific subject is extracted from the color image, the image processing unit 190 synthesizes the extracted color image with the region at which the specific subject is positioned in the depth image to generate the synthesized image.

The control unit 110 stores the synthesized image generated by the image processing unit 190 in the storage unit 160 as the surveillance image and transmits the surveillance image stored in the storage unit 160 to the security center through the communication unit 150.

Meanwhile, although not illustrated in FIG. 1, the surveillance image providing apparatus 100 according to the present invention may further include the input unit. Herein, the input unit as a means for receiving a control command from a manager may correspond to a key button implemented outside the surveillance image providing apparatus 100 and also correspond to a soft key implemented on the display. Further, the input unit may be an input means such as a mouse, a joystick, a jog shuttle, and a stylus pen.

As one example, the input unit may receive setting information for the first and second cameras 120 and 130 from the manager and receive setting information required for the subject identification, the skeleton information extraction, and the image processing.

As described above, the surveillance image providing apparatus 100 according to the present invention provides the color image only to the region corresponding to the corresponding subject only when the specific subject is identified and provides the depth image to a region where the specific subject is not identified to provide the surveillance image capable of protecting the individual privacy.

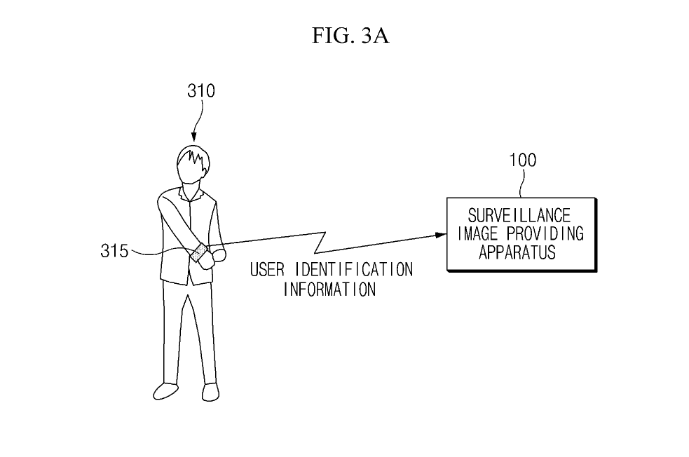

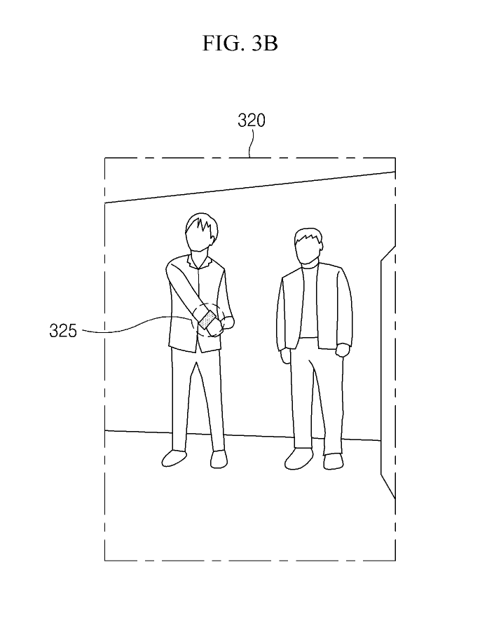

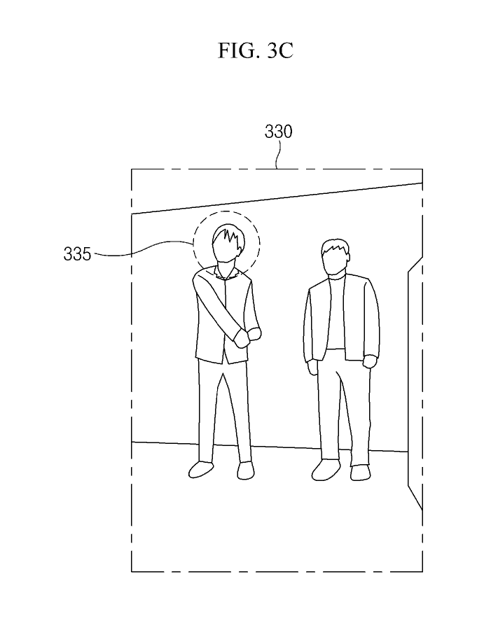

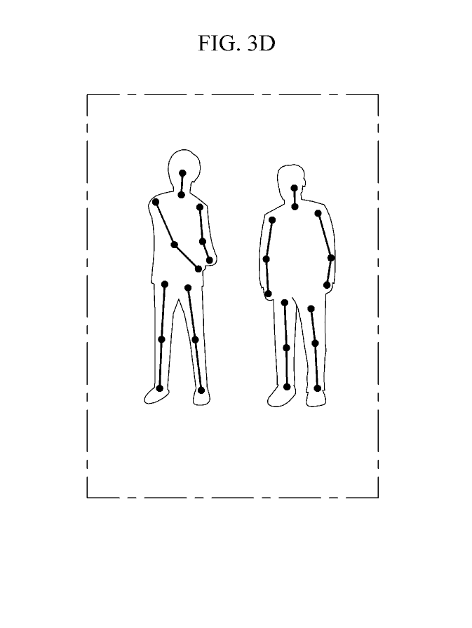

FIGS. 3A to 3D is a diagram illustrating an exemplary embodiment of an operation of identifying the specific subject in the apparatus for providing a surveillance image based on a depth image according to the present invention.

First, FIG. 3A illustrates an exemplary embodiment of identifying a specific subject positioned in a capturing region through short-range communication with a sensor which a specific subject wears.

Referring to FIG. 3A, the subject designated as the interest object may wear a sensor in which interest object information is registered in advance. Herein, the sensor which the interest object wears transmits the registered interest object information to the outside within a predetermined range.

The surveillance image providing apparatus may receive the interest object information transmitted from the sensor which the interest object positioned in the predetermined range wears from the surveillance image providing apparatus.

In this case, the surveillance image providing apparatus recognizes the information of the corresponding subject based on the interest object information received from the corresponding sensor and identifies the specific subject positioned in the designated capturing region based on a transmission position where the corresponding signal is received. In this case, the surveillance image providing apparatus may extract the positional information of the specific subject in the depth image and/or the color image from the position of the specific subject positioned in the designated capturing region.

FIGS. 3B and 3C illustrate an exemplary embodiment of identifying a specific subject from a feature value of a color image.

Referring to FIG. 3B, the subject designated as the interest object may wear an identification means which may be verified outside in advance.

In this case, the surveillance image providing apparatus analyzes the color image to detect the identification means which the specific subject wears and identify the specific subject positioned in the designated capturing region from the detected identification means. In this case, the surveillance image providing apparatus may extract the positional information of the specific subject in the depth image and/or the color image from the position of the specific subject positioned in the designated capturing region.

Referring to FIG. 3C, the surveillance image providing apparatus may previously store a face image of the interest object. In this case, the surveillance image providing apparatus analyzes the color image to extract the face image in the color image and compares the face image in the color image with the face image of the interest object which is previously stored to identify the specific subject positioned in the designated capturing region. In this case, the surveillance image providing apparatus may extract the positional information of the specific subject in the depth image and/or the color image from the position of the specific subject positioned in the designated capturing region.

Referring to FIG. 3D, the surveillance image providing apparatus analyzes the depth image to extract the skeleton information of the subjects in the depth image and predict the motion and/or posture of each subject based on the extracted skeleton information. In this case, the surveillance image providing apparatus detects the suspicious action from the motion and/or posture information of each subject to identify the specific subject positioned in the designated capturing region. In this case, the surveillance image providing apparatus may extract the positional information of the specific subject in the depth image and/or the color image from the position of the specific subject positioned in the designated capturing region.

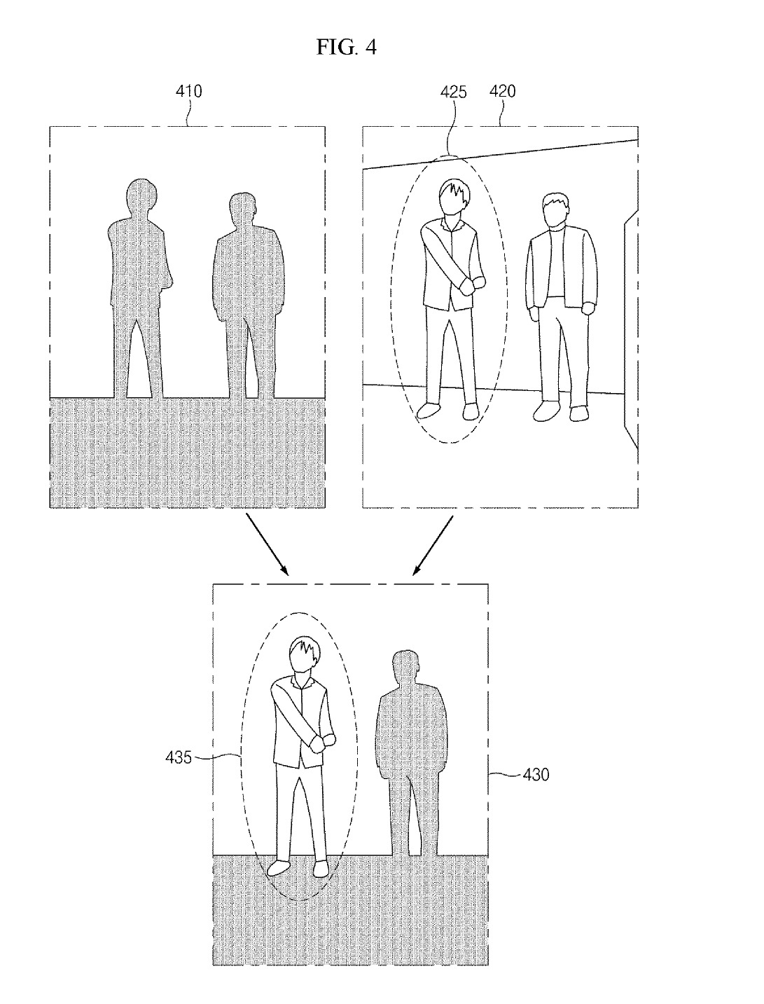

FIG. 4 is a diagram illustrating an exemplary embodiment of an operation of generating a synthesized image in the apparatus for providing a surveillance image based on a depth image according to the present invention.

Referring to FIG. 4, when the specific subject designated as the interest object or the specific subject performing the suspicious action is detected from the depth image, the surveillance image providing apparatus determines the position of the specific subject in the depth image and the position of the specific subject in the color image based on the identification information for the specific subject.

In this case, the surveillance image providing apparatus synthesizes a depth image 410 and a color image of a region 425 corresponding to the specific subject in a color mage 420 to generate a synthesized image 430.

Herein, the synthesized image 430 is based on the depth image 410 and includes a color image only for the region 435 corresponding to the specific subject.

In this case, the synthesized image 430 may be transmitted to the security center as the surveillance image and since the color image is provided to the specific subject in the security center, surveillance is easy and since images of residual regions other than the specific subject are monitored as the depth image, it is possible to protect the individual privacy.

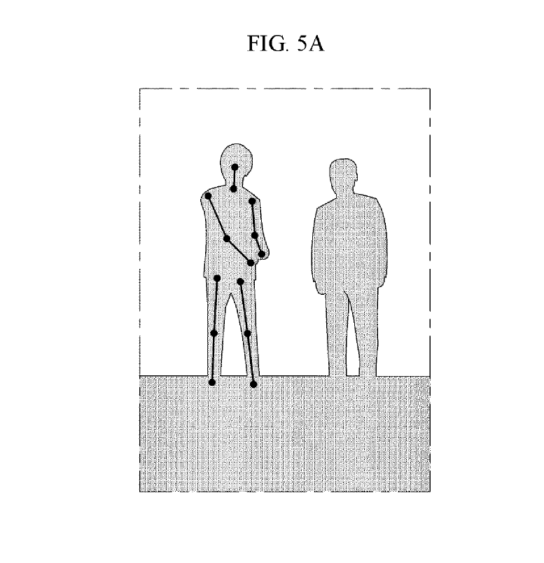

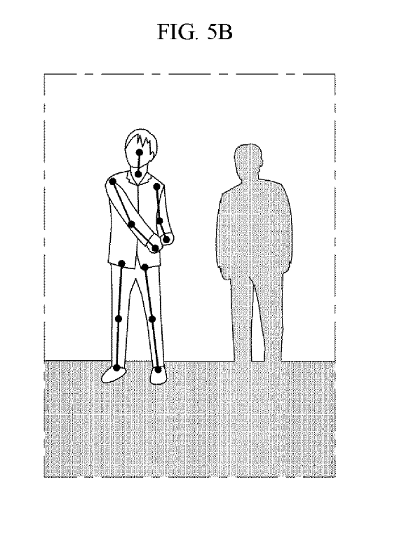

FIGS. 5A and 5B are diagrams illustrating an exemplary embodiment of an operation of encapsulating skeleton information in the surveillance image in the apparatus for providing a surveillance image based on a depth image according to the present invention.

The surveillance image providing apparatus according to the present invention may extract the skeleton information of the specific subject identified in the capturing region from the depth image. In this case, the extracted skeleton information may be used to predict the motion and/or posture of the corresponding subject.

Therefore, the surveillance image providing apparatus may generate the synthesized image by encapsulating the skeleton information of the specific subject in the depth image as illustrated in FIG. 5A or encapsulate the skeleton information of the specific subject in the synthesized image as illustrated in FIG. 5B.

As described above, the surveillance image may include the skeleton information of the specific subject and the surveillance image including the skeleton information is provided to the security center to be used for monitoring the motion and/or posture of the specific subject.

An operational flow of the apparatus according to the present invention, which is configured as above will be described below in more detail.

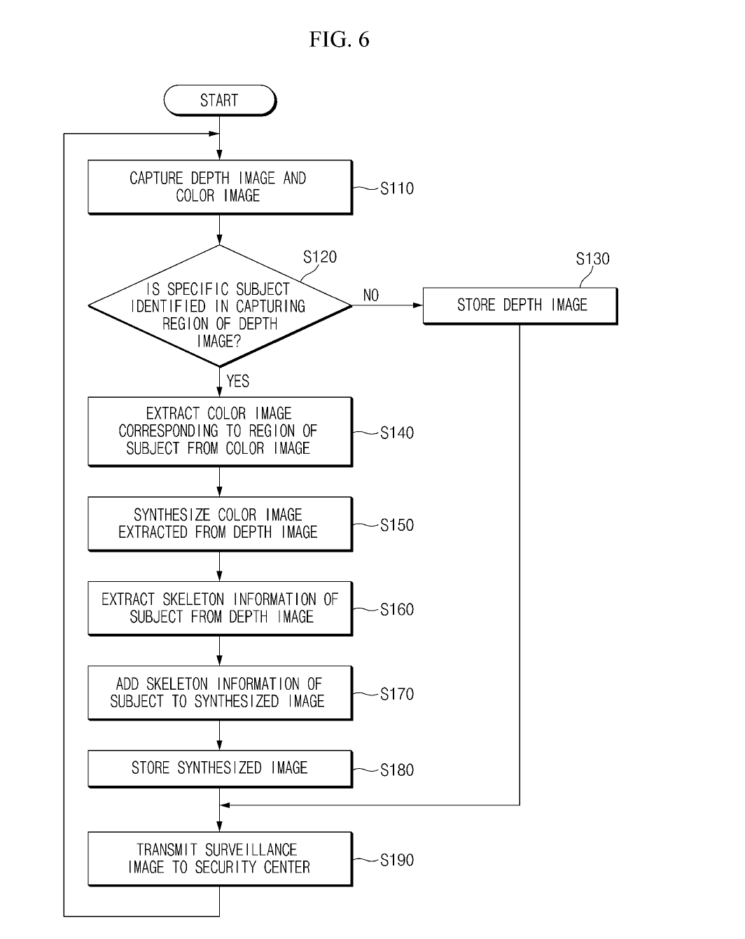

FIG. 6 is a diagram illustrating an operational flow for a method for providing a surveillance image based on a depth image according to the present invention.

Referring to FIG. 6, a surveillance image providing apparatus allows a first camera to capture a depth image and a second camera to capture a color image (S100).

When a specific subject is not identified in a capturing region (S120), the surveillance image providing apparatus stores the depth image as a surveillance image (S130) and transmits the stored surveillance image to the security center (S190).

Meanwhile, when the specific subject is identified in the capturing region during process ‘S120’ (S120), the surveillance image providing apparatus verifies positions of the specific subject in the depth image and the color image and extracts the color image corresponding to a region of the specific subject from the color image (S140).

Thereafter, the surveillance image providing apparatus synthesizes the color image extracted during process ‘S140’ with the region at which the specific subject is positioned in the depth image to generate the synthesized image (S150). In this case, the surveillance image providing apparatus may extract skeleton information of the specific subject from the depth image (S160) and add the extracted skeleton information to the region at which the corresponding subject is positioned in the synthesized image (S170).

The surveillance image providing apparatus stores the synthesized image to which the skeleton information is added as the surveillance image (S180) and transmits the stored surveillance image to the security center (S190). Of course, the surveillance image providing apparatus may store the synthesized image generated during process ‘S150’ as the surveillance image.

Herein, processes ‘S110’ to ‘S190’ may be repeatedly performed until operations of the first and second cameras end.

The surveillance image providing apparatus according to the exemplary embodiment, which operates as described above may be implemented as an independent hardware device form and the control unit, the subject identification unit, the skeleton information extracting unit, and the image processing unit of the surveillance image providing apparatus may be implemented as processors. Meanwhile, the surveillance image providing apparatus according to the exemplary embodiment as at least one processor may be driven while being included in another hardware device such as a microprocessor or a universal computer system.

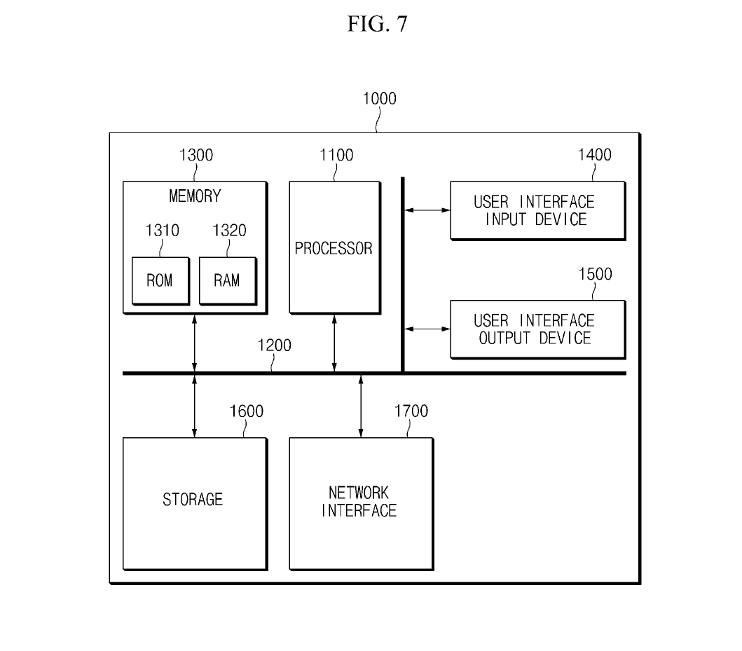

FIG. 7 is a diagram illustrating a computing system to which the apparatus according to the present invention is applied.

Referring to FIG. 7, the computing system 1000 may include at least one processor 1100, a memory 1300, a user interface input device 1400, a user interface output device 1500, a storage 1600, and a network interface 1700 connected through a bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a personal terminal. As yet another method, the processor and the storage medium may reside in the personal terminal as individual components.

The above description just illustrates the technical spirit of the present invention and various modifications and transformations can be made to those skilled in the art without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range is intended to be embraced by the scope of the present invention.

What is claimed is:

1. An apparatus for providing a surveillance image based on a depth image, the apparatus comprising:
a first camera capturing a depth image including distance information on a subject in a predetermined capturing region;
a second camera capturing a color image for the subject in the predetermined capturing region;
a subject identification unit identifying a subject designated as an interest object or a subject performing a suspicious action in the capturing region;
an image processing unit extracting the color image corresponding to a region of the identified subject from the color image and synthesizing the extracted color image with a position corresponding to the depth image to generate a synthesized image; and
a control unit providing the depth image as a surveillance image when the subject is not identified by the subject identification unit and providing the synthesized image as the surveillance image only when the subject is identified by the subject identification unit.

2. The apparatus of claim 1, wherein the subject identification unit identifies the corresponding subject positioned in the capturing region based on a signal received from a sensor which an interest object positioned in a predetermined range wears from the corresponding surveillance image providing apparatus.

3. The apparatus of claim 1, wherein the subject identification unit identifies the corresponding subject positioned in the capturing region by detecting an identification means which the interest object wears from the color image.

4. The apparatus of claim 1, wherein the subject identification unit identifies the corresponding subject positioned in the capturing region by detecting a face image corresponding to the interest object from the color image.

5. The apparatus of claim 1, further comprising:
a skeleton information extracting unit extracting skeleton information from the depth image.

6. The apparatus of claim 5, wherein the subject identification unit identifies the corresponding subject positioned in the capturing region by detecting a suspicious action based on the skeleton information extracted from the depth image.

7. The apparatus of claim 5, wherein the skeleton information extracting unit extracts the skeleton information corresponding to the identified object from the depth image.

8. The apparatus of claim 7, wherein the image processing unit adds the skeleton information corresponding to the identified subject to the region corresponding to the corresponding subject in the depth image.

9. The apparatus of claim 7, wherein the image processing unit adds the skeleton information corresponding to the identified subject to the region corresponding to the corresponding subject in the synthesized image.

10. The apparatus of claim 1, wherein the image processing unit determines positional information of the region of the identified subject in the depth image and extracts a color image of a region extended at a predetermined ratio based on the region corresponding to the determined positional information in the color image.

11. The apparatus of claim 1, wherein the image processing unit extracts an outline for the identified subject in the depth image and extracts a color image of a region matching the extracted outline in the color image.

12. A method for providing a surveillance image based on a depth image, the method comprising:
capturing a depth image including distance information for a subject in a predetermined capturing region by a first camera and capturing a color image for the subject in the predetermined capturing region by a second camera;
identifying a subject designated as an interest object or a subject performing a suspicious action in the capturing region; and
providing the depth image as a surveillance image when the subject is not identified in the capturing region and providing a synthesized image generated by synthesizing a color image corresponding to the region of the identified subject with a position corresponding to the depth image as the surveillance image in the color image when the object is identified in the capturing region.

13. The method of claim 12, wherein in the identifying of the subject, the corresponding subject positioned in the capturing region is identified based on a signal received from a sensor which an interest object positioned in a predetermined range wears from the corresponding surveillance image providing apparatus.

14. The method of claim 12, wherein in the identifying of the subject, the corresponding subject positioned in the capturing region is identified by detecting an identification means which the interest object wears from the color image.

15. The method of claim 12, wherein in the identifying of the subject, the corresponding subject positioned in the capturing region is identified by detecting a face image corresponding to the interest object from the color image.

16. The method of claim 12, further comprising:
extracting skeleton information from the depth image.

17. The method of claim 16, wherein in the identifying of the subject, the corresponding subject positioned in the capturing region is identified by detecting a suspicious action based on the skeleton information extracted from the depth image.

18. The method of claim 12, further comprising:
extracting the skeleton information corresponding to the identified subject from the depth image.

19. The method of claim 18, further comprising:
adding the skeleton information corresponding to the identified subject to the region corresponding to the corresponding subject in the depth image.

20. The method of claim 18, further comprising:
adding the skeleton information corresponding to the identified subject to the region corresponding to the corresponding subject in the synthesized image.
